(19) United States
(12) Patent Application Publication
(10) Pub. No.: US 2014/0036223 A1
(43) Pub. Date: Feb. 6, 2014

(54) SELF-HEALING TRANSPARENT COATINGS CONTAINING MINERAL CONDUCTIVE COLLOIDS

(71) Applicant: Essilor International (Compagnie Generale D'Optique), Charenton-Le-Pont (FR)

(72) Inventor: Haipeng Zheng, St. Petersburg, FL (US)

(73) Assignee: Essilor International (Compagnie Generale D'Optique), Charenton-Le-Pont (FR)

(21) Appl. No.: 13/954,299

(22) Filed: Jul. 30, 2013

Related U.S. Application Data
(63) Continuation-in-part of application No. PCT/US2011/023550, filed on Feb. 3, 2011.

(51) Int. Cl. G02B 1/10; G02C 7/02

(52) U.S. Cl. CPC G02B 1/105; G02C 7/022
USPC 351/159.01; 264/2.6; 427/164; 427/508; 428/419; 428/335

(57) ABSTRACT

The present invention is drawn to an optical article comprising
(a) a transparent optical substrate and
(b) a transparent coating, said transparent coating being the outermost coating of the optical article and consisting essentially of
a polythiol-ene matrix obtained by curing a liquid monomer mixture comprising at least one polyfunctional thiol and at least one polyfunctional allyl monomer, said cured polythiol-ene matrix having a glass transition temperature comprised in the range of from 40° C. to 70° C., and
from 0.5 to 7% by weight of conductive mineral colloids homogeneously dispersed therein.

It is also drawn to a method for preparing such an optical article and to a method for repairing scratches on such an optical article by heating.

### CROSS-REFERENCE TO RELATED APPLICATIONS

This application is a continuation-in-part of International Patent Application No. PCT/US2011/023550, filed Feb. 3, 2011, and published as WO 2012/105974.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention is drawn to optical articles with self-healing transparent coatings containing mineral conductive colloids, to a method for manufacturing such optical articles, and also to a method for repairing scratches in the self-healing coating of such an article.

### BACKGROUND

The development of optical elements, including ophthalmic lenses, manufactured from plastic materials has also required the development of protective coatings providing good abrasion resistance and/or scratch resistance.

In the optical field there is still considerable endeavor and research for improving the known hard-coatings to make them ever more abrasion and scratch resistant.

A rather new and very interesting route for solving the problem of scratches and/or abrasion of organic glasses is to protect the lenses with coating layers able to repair themselves, i.e. coatings which would be able, when submitted to a simple physical treatment, to revert completely or partially to the initial non-scratched condition. The use of such self-healing coatings as clear top coats in the automotive industry has been described for example in US 2009/06453 and WO 2009/029641.

Cornerstone Research Group Inc. has marketed two transparent shape memory polymers, Veriflex® (a polystyrene base resin) and Veriflex® E (a two-part epoxy-based resin), showing interesting self-healing performances. Preliminary experimental tests carried out by the inventors have however shown that these coatings suffer either from excessive initial haze and/or from very poor scratch resistance.

### SUMMARY OF THE INVENTION

Provided is an optical article comprising
(a) a transparent optical substrate and
(b) a transparent coating, said transparent coating being the outermost coating of the optical article and consisting essentially of
a polythiol-ene matrix obtained by curing a liquid monomer mixture comprising at least one polyfunctional thiol and at least one polyfunctional allyl monomer, said cured polythiol-ene matrix having a glass transition temperature comprised in the range of from 40° C. to 70° C., and
from 0.5 to 7% by weight of conductive mineral colloids homogeneously dispersed therein.

Also provided is a method for preparing an optical article and a method for suppressing scratches on an optical article.

### DETAILED DESCRIPTION

The present invention is based on the discovery that a class of known thermocured or photocured resins obtained by thiol-ene reactions and used heretofore as UV-curable adhesives, display interesting transparency and a shape memory effect with transition temperature in the range of 45 to 65° C. These resins are the Norland Optical Adhesives (NOA) marketed by Norland Products Inc. When tested as protective coatings on ophthalmic lenses, these resins showed healing levels similar to the Veriflex® coatings in the Manual Brass Brush test (described hereafter), but turned out to display lower healing levels for some deeper scratches (up to 3 μm depth) generated by the Automated Steel Wool test (described hereafter).

The Applicants therefore have tried to improve the healing performance of said thiol-ene resins by incorporating colloidal particles into the monomer mixture before curing.

A large number of colloids have been tested, most of which turned out to be “non-compatible” with the liquid monomer mixture, in other words it has not been possible to prepare a homogenous, clear and stable suspension of the particles in the monomer mixture.

The Applicants, after having selected a few colloids compatible with the monomer mixture, have further observed that non-conductive colloids, such as silica, desirably improved the healing performances of the final cured resin coatings. This effect was however undesirably counteracted by lower scratch resistance, eventually leading to a much higher haze value.

It was only when incorporating conductive colloids such as Sb₂O₅ or SnO₂ into the known thiol-ene resins that the Applicants obtained cured coatings having both of significantly increased healing levels and lower final haze values.

In its first aspect, the present invention is therefore drawn to an optical article comprising
(a) a transparent optical substrate, and
(b) a transparent coating, said transparent coating being the outermost coating of the optical article and consisting essentially of
   a polythiol-ene matrix obtained by curing a liquid monomer mixture comprising at least one polyfunctional thiol and at least one polyfunctional allyl monomer, said cured polythiol-ene matrix having a glass transition temperature comprised in the range of from 40° C. to 70° C., preferably in the range of from 45° C. to 65° C., and
   from 0.5 to 7% by weight of conductive mineral colloids homogeneously dispersed therein.

The optical substrate may be any organic glass commonly known and used in the optical field. It may be a thermoplastic resin such as thermoplastic polycarbonate, or a thermoset or photo-cured resin such as CR 39®, polyurethane or polythiourethane. Its selection is not critical to the present invention.

The transparent self-healing coating is not necessarily in contact with the underlying optical substrate and there may be one or more intermediate layers, such as a primer layer, a polarizing layer, anti-reflection layers, etc. Each of these intermediate layers should be also transparent.

The final cured coating of the optical article is a composite of
a polymer matrix based on a thiol-ene resin, and
conductive mineral colloids homogeneously dispersed in said polymer matrix.

The cured coating is thus essentially free of any other component which is not part of the polymer matrix or the colloids, such as solvents, non-colloidal mineral fillers, fibres, organic fillers, etc.

This however does not mean that the polythiol-ene matrix is the only polymer component of the self-healing coating of the present invention. There may be a minor amount of another oligomer or polymer component, said component being either covalently bound to the polythiol-ene matrix or homogeneously incorporated therein. This additional oligomer or polymer component must be sufficiently compatible with both of the liquid monomer mixture and the cured resin to prevent any phase separation during or after the curing procedure which would inevitably lead to excessive haze of the final coating. The amount of the additional oligomer or polymer component in the polymer matrix preferably is not higher than about 30% by weight, preferably not higher than 20% by weight, and most preferably not higher than 10% by weight.

In a preferred embodiment of the present invention the polyfunctional thiol in the liquid monomer mixture is a tetrathiol of formula (1)

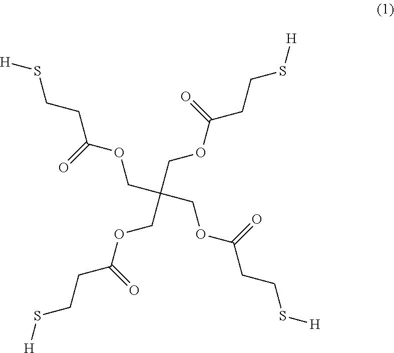 [SMILES: O=C(CCS)OCC(COC(=O)CCS)(COC(=O)CCS)COC(=O)CCS]

This tetrathiol preferably is reacted with triallyl isocyanurate as the polyfunctional allyl monomer. The weight ratio of the polyfunctional thiol to the polyfunctional allyl monomer is preferably comprised in the range of from 55/45 to 57/43.

As explained above, the polyfunctional thiol and the polyfunctional allyl monomer are the major components of the liquid monomer mixture. They preferably comprise at least 70% by weight, more preferably at least 80% by weight, and even more preferably at least 90% by weight of the liquid monomer mixture. In a particularly preferred embodiment, the liquid monomer mixture essentially consists of polyfunctional thiols, polyfunctional allyl monomers, and/or of a suitable amount of photo-initiators or catalysts.

Liquid UV curable monomer mixtures comprising or consisting essentially of a polyfunctional thiol and a polyfunctional allyl monomer as defined hereabove are marketed under the reference NOA 61, NOA 63, NOA 65 and NOA 68 by Norland Products Inc. NOA 61 and NOA 63 lead to very low haze values of finally healed coatings and therefore are the most preferred curable monomer mixtures. NOA 61 essentially consists of 55-57 weight % of tetrathiol of formula (1) and 43-45 weight % of triallyl isocyanurate. NOA 63 contains about 70-75 weight % of NOA 61 and about 25-30 weight % of a urethane component.

The conductive colloids used in the present invention have an average particle size comprised in the range of 5 to 25 nm. They may be selected from the group consisting of Sb₂O₅, SnO₂, ATO (SnO₂/Sb₂O₅), PTO (SnO₂/P₂O₅).

As will be apparent from the examples, the Applicants have observed that colloidal nanoparticles Sb₂O₅ and SnO₂, when added in a sufficient but not too high amount, significantly increase the self-healing performance of polythiol-ene matrices as defined above and also are satisfactory both with regard to the initial haze of the coating and with regard to the haze after a self-healing step. These conductive metallic oxides therefore are particularly preferred in the present invention.

The mineral conductive colloids are present in the final cured coating in an amount from 0.5 to 7% by weight, preferably from 1 to 6% by weight. At lower concentrations, the self-healing performance of the final coating is not significantly increased. When the concentration of the conductive colloid is too high, i.e. above 7%, the scratch resistance, the haze value after healing, and the healing performance of the final coating are surprisingly reduced with respect to lower concentrations.

There is no particular limitation as to the thickness of the self-healing coating of the present invention. The coating should be sufficiently thick to efficiently protect the underlying substrate and optional functional layers. Excessive coating thickness could however be detrimental to transparency of the final optical article.

The self-healing coatings consequently have a thickness similar to known abrasion resistant coatings which is typically comprised in the range of 2 μm to 50 μm, preferably of 5 μm to 20 μm.

The optical article preferably is a lens, such as an ophthalmic lens, sunglass lens or other optical lens, and most preferably is an ophthalmic lens. As mentioned above, it may contain functional layers such as polarizing layers, anti-reflective coatings, visible light and UV absorbing coatings, anti-choc coatings, photochromic coatings, all of which are familiar to the skilled person.

The present invention is also drawn to a method for manufacturing an optical article having a self-healing component according to the present invention. Such a manufacturing method comprises:
homogeneously dispersing a conductive mineral colloid, in an amount comprised in the range of 0.5 to 7% by weight relative to the total dry weight of the dispersion, in a liquid monomer mixture comprising at least one polyfunctional thiol and at least one polyfunctional allyl monomer,
coating the resulting dispersion onto a transparent optical substrate, and
curing the resulting layer by submitting the coated substrate to UV light and/or heat.

The conductive mineral colloid may first be dispersed in an organic solvent, such as a lower alkanol or a glycol alkyl ether, for example Dowanol PM (propyleneglycol methyl ether).

A wetting agent (surfactant) may also be added to the coating composition, preferably in an amount not exceeding about 0.2% by weight of the total coating composition. A preferred wetting agent is EFKA®-3034, a fluorocarbon-modified polysiloxane sold by Ciba Specialty Chemicals.

The liquid monomer mixture with the conductive colloid dispersed therein is then coated onto the optical substrate, or a functional layer overlaying the optical substrate. The dispersion may be coated by any suitable coating method such as dip-coating, bar coating, spray coating, or spin coating. Spin coating is most preferred.

The coated substrate may be submitted to a drying step at room temperature or at elevated temperature for example at a temperature ranging from 30 to 120° C., in order to evaporate the solvent used for dispersing the conductive colloid.

The optionally dried coating is then submitted to UV irradiation, preferably with a UV radiation dosage ranging from 0.150 J/cm² to 1.20 J/cm² in the UV-C range (290 nm-100 nm).

The present invention is also drawn to a method for suppressing scratches on an optical article according to the present invention. Said method comprises heating the optical article with the cured and scratched self-healing coating to a temperature at least equal to the glass transition temperature of the polythiol-ene matrix. The coating may be heated by conduction or convection. The heating medium may be a gas, for example warm or hot air. In a preferred embodiment, the heating is carried out by contacting the outermost scratched coating of the optical article with a warm or hot liquid, preferably warm or hot water. The heating is preferably maintained for a duration comprised in the range of 1 to 60 minutes, preferably of 10 to 30 minutes.

The self-healing performance, or “healing level”, of the coatings is assessed using two different scratch/abrasion tests, generating scratches with different depths.

Manual Brass Brush Test (MBB Test):

Initial haze (Haze₀) of a coated lens is measured using a Haze Guard XL-211 plus meter using the standard method ASTM D 1003-00. The convex side of the lens is first rubbed with a brass brush (Weiler 44189, Block size L×W: 7.5 inches×0.5 inch, Bristle rows: 3×7, Trim length: 0.5 inche) for ten forward strokes. The haze of the scratched lens (Hazeₛ) is then measured under the same conditions as the initial haze. The scratches made by this method are analyzed by profilometer and confirmed to be in the range from 0 to 1 μm in depth, most scratches being less than 0.6 μm in depth, except some larger scratches having a depth higher than 1 μm on Veriflex® coatings.

Automated Steel Wool Test (ASW Test):

Initial haze (Haze₀) of a coated lens is measured using a Haze Guard XL-211 plus meter using the standard method ASTM D 1003-00. The convex side of the lens is first rubbed with steel wool (000 grade) for 5 cycles (1 cycle=1 forward and 1 backward motion) under 1200 g of load using the automated steel wool machine. The haze of the scratched lens (Hazeₛ) is then measured under the same conditions as the initial haze. The scratches made by this method are analyzed by profilometer and confirmed to be in the range of from 0 to 3 μm in depth, except some larger scratches having a depth higher than 3 μm on Veriflex® coatings.

The lenses submitted to the MBB test or ASW test are subsequently immersed in warm water at 60° C. for 15 minutes and are taken out from the water to cool down at room temperature. The haze (Hazeₕ) of a lens after this healing process is measured with a Haze Guard XL-211 plus meter using the standard method ASTM D 1003-00.

The healing level is then calculated as follows:

$$Healing level ( \% ) = \frac{{Haze}_{s} - {Haze}_{h}}{{Haze}_{s}} \times 100.$$

Although the present invention and its advantages have been described in detail, it should be understood that various changes, substitutions and alterations can be made herein without departing from the spirit and scope of the invention as defined in the appended claims. The present invention will be further illustrated in the following Examples which are given for illustration purposes only and are not intended to limit the invention in any way.

### EXAMPLES

### Example 1

### Healing Level of Norland Optical Adhesives (NOA) in Comparison with Commercial Veriflex® Coatings

The following coating solutions A, B, C and D were prepared by adding a solvent propylene glycol methyl ether (Dowanol® PM from Dow) or tetrahydrofuran (THF from Aldrich) into NOA 61, 63, 65, and 68, respectively, shown in Table 1.

TABLE 1

| | |
|---|---|
| NOA | Solvent |

| Solution | Type | Weight (g) | Type | Weight (g) |
|---|---|---|---|---|
| A | NOA 61 | 30.0 | Dowanol PM | 20.0 |
| B | NOA 63 | 20.0 | Dowanol PM | 30.0 |
| C | NOA 65 | 5.6 | THF | 10.4 |
| D | NOA 68 | 4.8 | THF | 11.2 |

The coatings were prepared by spin coating on plano CR39® lenses (Orma lenses) at a speed of 400-600 rpm for 10 seconds and then 800-1000 rpm for 5 seconds to get a coating thickness of about 5 μm. The coatings were then cured by passing them twice in a Fusion Systems® UV belt conveyor at a speed of 6 feet/min (1.83 m/min).

The below Table 2 shows the results of some basic coating performance tests carried out on the resulting coatings A, B, C, and D.

TABLE 2

| | | Refractive | | | Bayer | |
|---|---|---|---|---|---|---|
| Coat- | Thickness | Index | Haze₀ | T | abrasion | Yellow |
| ing | (μm) | at 632 nm | (%) | (%) | test | index |
| A | 5.1 | 1.564 | 0.15 | 91.3 | 0.64 | 1.6 |
| B | 5.0 | 1.549 | 0.13 | 91.4 | 0.45 | 1.4 |
| C | 5.0 | 1.525 | 0.17 | 91.7 | 0.35 | 1.5 |
| D | 5.1 | 1.541 | 0.15 | 91.5 | 0.33 | 1.5 |

All these coatings show excellent initial transparency with a Haze₀ value of only about 0.13 to 0.17 whereas the Haze₀ value of Veriflex® coatings is much higher, about 1.2%. As seen in Table 2, the Bayer abrasion test results of the coatings A (NOA 61) and B (NOA 63) were better than the coatings C (NOA 65) and D (NOA 68). So the coatings resulting from these two liquid monomer mixtures were submitted to the ASW test and the MBB test.

TABLE 3

| Coating on | | | | Healing |
|---|---|---|---|---|
| CR39 ® | Haze₀ (%) | | Hazeₕ (%) | level (%) |
| | | Hazeₛ after | | |
| | | MBB test (%) | | |
| A | 0.15 | 3.22 | 0.42 | 87 |
| B | 0.19 | 2.59 | 0.37 | 86 |
| Veriflex ® | 1.17 | 28.20 | 2.66 | 91 |
| | | Hazeₛ after | | |
| | | ASW test (%) | | |
| A | 0.17 | 2.69 | 1.71 | 36 |
| B | 0.12 | 3.35 | 2.12 | 37 |
| Veriflex ® | 1.21 | 46.7 | 6.32 | 87 |

The coatings A and B prepared respectively from NOA 61 and NOA 63 proved to have a much higher scratch resistance than the Veriflex® coatings. The healing performances of the coatings A and B were satisfactory for superficial scratches such as those generated by the MBB test. When submitted to the ASW test, some deeper scratches could however not be repaired by immersing the coating into warm water for 15 minutes and the final haze values were about 2% which is not quite satisfactory for optical applications. We will show hereafter how the incorporation of conductive mineral colloids leads to a significant improvement of the healing performances of the A and B resins, resulting in final haze values lower than 1%.

### Example 2

### Incorporation of Non-Conductive Mineral Colloids

Four liquid monomer mixtures A1 to A4 were prepared by adding a dispersion of colloidal silica (Osca 1122-A8, 15-25 wt % dispersion from JGC), Dowanol® PM, and a wetting agent (EFKA-3034 from Ciba Specialty Chemicals) into the solution A of Table 1.

TABLE 4

| | Solution A | Osca | Dowanol PM | EFKA-3034 |
|---|---|---|---|---|
| Solution | (g) | (g) | (g) | (g) |
| A1 | 95.0 | 1.5 | 3.0 | 0.1 |
| A2 | 89.0 | 5.5 | 6.0 | 0.1 |
| A3 | 90.0 | 8.5 | 7.0 | 0.1 |
| A4 | 86.5 | 10.5 | 8.0 | 0.1 |

The coatings were prepared and cured in the way described in Example 1.

Table 5 shows the results of some basic coating performance tests carried out on the resulting coatings A1 to A4.

TABLE 5

| | | Mineral | | | | | |
|---|---|---|---|---|---|---|---|
| | Thick- | colloid | Refractive | | | Bayer | |
| Coat- | ness | content | Index | Haze₀ | T | abrasion | Yellow |
| ing | (μm) | (wt %) | at 632 nm | (%) | (%) | test | index |
| A1 | 5.3 | 0.52 | 1.562 | 0.33 | 91.2 | 0.56 | 1.8 |
| A2 | 5.2 | 1.92 | 1.558 | 0.80 | 90.7 | 0.74 | 2.0 |
| A3 | 5.2 | 2.90 | 1.555 | 0.87 | 90.6 | 0.74 | 2.1 |
| A4 | 5.4 | 3.70 | 1.553 | 0.68 | 90.5 | 0.76 | 2.2 |

All coatings have acceptable initial haze values (Haze₀) below 1%.

Coating A from Example 1 and Coatings A1 to A4 containing from 0.52 to 3.7 wt % of colloidal silica were then submitted to the above-described ASW test. After measuring the haze of the scratched coating, the optical article was immersed for 15 minutes in warm water at a temperature of 60° C. The results are shown in Table 6.

TABLE 6

| Coating | Haze₀ (%) | Hazeₛ (%) | Hazeₕ (%) | Healing level (%) |
|---|---|---|---|---|
| A | 0.17 | 2.69 | 1.71 | 36 |
| A1 | 0.29 | 3.83 | 1.51 | 61 |
| A2 | 0.69 | 5.41 | 2.33 | 57 |
| A3 | 0.84 | 4.04 | 2.26 | 44 |
| A4 | 0.48 | 4.03 | 2.07 | 49 |

It appears that all but one silica-containing coating show higher final haze values and all silica-containing coatings show lower scratch resistance than the coating A, in spite of the increased healing performances (healing levels of 44-61% in comparison with 36% of the control).

These results demonstrate that the incorporation of non-conductive colloids in NOA 61 monomer mixtures, desirably improves the healing performances of the final cured resin coatings, but this effect is undesirably counteracted by lower scratch resistance, eventually leading to similar or even higher values of the final haze.

### Example 3

### Incorporation of Conductive Mineral Colloids

The following eight liquid monomer mixtures were prepared by adding a dispersion of colloidal Sb₂O₅ nanoparticles (ELCOM NE 1002 SBV, 19 wt % dispersion from JGC) or SnO₂ (ELCOM NE 1003 PTV, 15-25 wt % dispersion from JGC), Dowanol® PM and a wetting agent (EFKA-3034 from Ciba Specialty Chemicals) into the liquid monomer solutions A or B, respectively (Table 1).

TABLE 7

| | | | Conductive colloid | | | |
|---|---|---|---|---|---|---|
| Coat- | Solution | | dispersion | | Dowanol | EFKA-3034 |
| ing | Type | Weight (g) | Type | Weight (g) | PM (g) | (g) |
| A5 | A | 93.0 | Sb₂O₅ | 3.0 | 4.0 | 0.1 |
| A6 | A | 88.0 | Sb₂O₅ | 11.0 | 1.0 | 0.1 |
| A7 | A | 84.0 | Sb₂O₅ | 16.0 | 0 | 0.1 |
| A8 | A | 80.0 | Sb₂O₅ | 20.0 | 0 | 0.1 |
| A9 | A | 90.0 | SnO₂ | 3.0 | 7.0 | 0.1 |
| A10 | A | 90.0 | SnO₂ | 7.0 | 3.0 | 0.1 |
| B1 | B | 94.0 | Sb₂O₅ | 2.0 | 4.0 | 0.1 |
| B2 | B | 90.0 | Sb₂O₅ | 7.5 | 2.5 | 0.1 |

The coatings were prepared and cured in the way described in Example 1.

Table 8 shows the results of some basic coating performance tests carried out on the resulting coatings A5-A10 and B1-B2.

TABLE 8

| | | Mineral | | | | | |
|---|---|---|---|---|---|---|---|
| | Thick- | colloid | Refractive | | | | |
| Coat- | ness | content | Index | Haze₀ | T | Bayer | Yellow |
| ing | (μm) | (wt %) | at 632 nm | (%) | (%) | abrasion | index |
| A5 | 4.9 | 1.0 | 1.565 | 0.15 | 91.0 | 0.59 | 1.5 |
| A6 | 5.0 | 3.8 | 1.568 | 0.18 | 90.8 | 0.63 | 1.5 |
| A7 | 5.0 | 5.7 | 1.569 | 0.16 | 90.7 | 0.67 | 1.5 |
| A8 | 5.0 | 7.3 | 1.571 | 0.21 | 90.5 | 0.67 | 1.5 |
| A9 | 5.0 | 1.0 | 1.564 | 0.18 | 90.7 | 0.60 | 1.7 |
| A10 | 4.9 | 2.4 | 1.566 | 0.19 | 90.6 | 0.62 | 1.8 |
| B1 | 4.9 | 1.0 | 1.553 | 0.21 | 91.1 | 0.58 | 1.2 |
| B2 | 4.7 | 3.8 | 1.555 | 0.21 | 91.0 | 0.65 | 1.2 |

All coatings have acceptable initial haze values (Haze₀) below 1%.

The coatings of Table 8 were then submitted to the above-described ASW test. The results in comparison with the unfilled resins A and B are shown in Table 9.

TABLE 9

| Coating | Haze₀ (%) | Hazeₛ (%) | Hazeₕ (%) | Healing level (%) |
|---|---|---|---|---|
| A | 0.17 | 2.69 | 1.71 | 36 |
| A5* | 0.13 | 2.80 | 0.81 | 71 |
| A6* | 0.16 | 2.82 | 0.61 | 78 |
| A7* | 0.23 | 2.65 | 0.54 | 80 |
| A8 | 0.17 | 4.13 | 1.99 | 52 |
| A9* | 0.20 | 2.75 | 0.98 | 64 |
| A10* | 0.22 | 2.58 | 0.69 | 73 |
| B | 0.12 | 3.35 | 2.12 | 37 |
| B1* | 0.18 | 3.39 | 1.95 | 42 |
| B2* | 0.14 | 3.27 | 1.76 | 46 |

*according to the invention

These results demonstrate the excellent self healing performances of the NOA 61 resin coatings containing conductive Sb₂O₅ or SnO₂ colloids:
all final haze values (Haze_{H}) are less than 1.0%;
the healing level is significantly improved with respect to the comparative coating A,
comparative coating A8 shows that the amount of colloids added to the resin should not exceed a maximum value of about 7% by weight.

The incorporation of the conductive colloids does not lower the coating scratch resistance, compared with the colloid-free coatings A and B, respectively.

The invention will be further described by the following numbered paragraphs:

1. An optical article comprising
(a) a transparent optical substrate and
(b) a transparent coating, said transparent coating being the outermost coating of the optical article and consisting essentially of
   a polythiol-ene matrix obtained by curing a liquid monomer mixture comprising at least one polyfunctional thiol and at least one polyfunctional allyl monomer, said cured polythiol-ene matrix having a glass transition temperature comprised in the range of from 40° C. to 70° C., and
   from 0.5 to 7% by weight of conductive mineral colloids homogeneously dispersed therein.

2. The optical article according to paragraph 1, wherein the polyfunctional thiol is a tetrathiol of formula

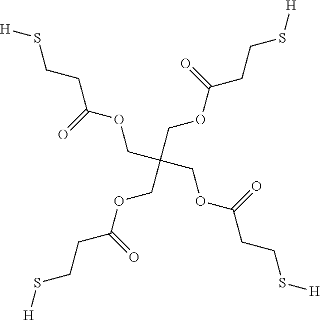 [SMILES: O=C(CCS)OCC(COC(=O)CCS)(COC(=O)CCS)COC(=O)CCS]

3. The optical article according to paragraph 1, wherein the polyfunctional allyl monomer is triallyl isocyanurate.

4. The optical article according to paragraph 1, wherein the polyfunctional thiol and polyfunctional allyl monomers comprise at least 70% by weight, preferably at least 80% by weight, and more preferably at least 90% by weight of the liquid monomer mixture.

5. The optical article according to paragraph 1, wherein the weight ratio of the polyfunctional thiol to the polyfunctional allyl monomer is comprised in the range of 55/45 to 57/43.

6. The optical article according to paragraph 1, wherein the glass transition temperature of the matrix is comprised in the range of from 45° C. to 65° C.

7. The optical article according to any of claims 1 to 6, wherein the conductive mineral colloids are selected from the group consisting of Sb₂O₅, SnO₂, ATO (SnO₂/Sb₂O₅), PTO (SnO₂/P₂O₅).

8. The optical article according to paragraph 1, wherein the transparent coating comprises from 1 to 6% by weight of conductive mineral colloids homogeneously dispersed therein.

9. The optical article according to paragraph 1, wherein the final cured transparent coating has a thickness comprised in the range of 2 μm to 50 μm, preferably between 5 μm and 20 μm.

10. The optical article according to paragraph 1, said article being a lens, preferably an ophthalmic lens.

11. A method for suppressing scratches on an optical article according to paragraph 1, said method comprising heating said article to a temperature at least equal to the glass transition temperature of the polythiol-ene matrix.

12. The method according to paragraph 11, wherein the heating is carried out by contacting the outermost scratched coating with a warm or hot liquid, preferably warm or hot water, having a temperature at least equal to the glass transition temperature of the polythiol-ene matrix.

13. The method according to paragraph 11, wherein the heating is maintained for a duration comprised in the range of 1 to 60 minutes, preferably of 10 to 30 minutes.

14. A method for preparing an optical article according to paragraph 11, comprising
homogeneously dispersing a conductive mineral colloid, in an amount comprised in the range of 0.5 to 7% by weight relative to the total dry weight of the dispersion, in a liquid monomer mixture comprising at least one polyfunctional thiol and at least one polyfunctional allyl monomer,
coating the resulting dispersion onto a transparent optical substrate, and

curing the resulting layer by submitting the coated substrate to UV light and/or heat.

It is to be understood that the invention is not limited to the particular embodiments of the invention described above, as variations of the particular embodiments may be made and still fall within the scope of the appended claims.

1. An optical article comprising
(a) a transparent optical substrate and
(b) a transparent coating, said transparent coating being the outermost coating of the optical article and consisting essentially of
a polythiol-ene matrix obtained by curing a liquid monomer mixture comprising at least one polyfunctional thiol and at least one polyfunctional allyl monomer, said cured polythiol-ene matrix having a glass transition temperature comprised in the range of from 40° C. to 70° C., and
from 0.5 to 7% by weight of conductive mineral colloids homogeneously dispersed therein.

2. The optical article according to claim 1, wherein the polyfunctional thiol is a tetrathiol of formula

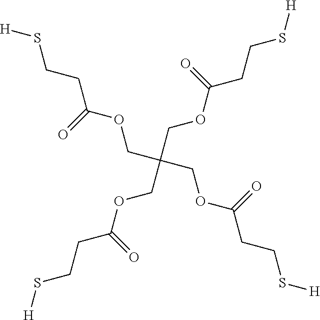 [SMILES: O=C(CCS)OCC(COC(=O)CCS)(COC(=O)CCS)COC(=O)CCS]

3. The optical article according to claim 1, wherein the polyfunctional allyl monomer is triallyl isocyanurate.

4. The optical article according to claim 1, wherein the polyfunctional thiol and polyfunctional allyl monomers comprise at least 70% by weight, preferably at least 80% by weight, and more preferably at least 90% by weight of the liquid monomer mixture.

5. The optical article according to claim 1, wherein the weight ratio of the polyfunctional thiol to the polyfunctional allyl monomer is comprised in the range of 55/45 to 57/43.

6. The optical article according to claim 1, wherein the glass transition temperature of the matrix is comprised in the range of from 45° C. to 65° C.

7. The optical article according to claim 1, wherein the conductive mineral colloids are selected from the group consisting of Sb₂O₅, SnO₂, ATO (SnO₂/Sb₂O₅), PTO (SnO₂/P₂O₅).

8. The optical article according to claim 1, wherein the transparent coating comprises from 1 to 6% by weight of conductive mineral colloids homogeneously dispersed therein.

9. The optical article according to claim 1, wherein the final cured transparent coating has a thickness comprised in the range of 2 μm to 50 μm, preferably between 5 μm and 20 μm.

10. The optical article according to claim 1, said article being a lens, preferably an ophthalmic lens.

11. A method for suppressing scratches on an optical article according to claim 1, said method comprising heating said article to a temperature at least equal to the glass transition temperature of the polythiol-ene matrix.

12. The method according to claim 11, wherein the heating is carried out by contacting the outermost scratched coating with a warm or hot liquid, preferably warm or hot water, having a temperature at least equal to the glass transition temperature of the polythiol-ene matrix.

13. The method according to claim 11, wherein the heating is maintained for a duration comprised in the range of 1 to 60 minutes, preferably of 10 to 30 minutes.

14. A method for preparing an optical article according to claim 1, comprising
homogeneously dispersing a conductive mineral colloid, in an amount comprised in the range of 0.5 to 7% by weight relative to the total dry weight of the dispersion, in a liquid monomer mixture comprising at least one polyfunctional thiol and at least one polyfunctional allyl monomer,
coating the resulting dispersion onto a transparent optical substrate, and
curing the resulting layer by submitting the coated substrate to UV light and/or heat.
